(19) United States
(12) Patent Application Publication
(10) Pub. No.: US 2026/0180619 A1
(43) Pub. Date: Jun. 25, 2026

(54) SYSTEMS, METHODS AND APPARATUS FOR HIGH ACCURACY TRACKING WITH ULTRA LOW POWER WIRELESS TAGS

(71) Applicant: GEORGIA TECH RESEARCH CORPORATION, Atlanta, GA (US)

(72) Inventors: Mohammad Rostami, Atlanta, GA (US); Karthikeyan Sundaresan, Atlanta, GA (US)

(21) Appl. No.: 19/126,739

(22) PCT Filed: Nov. 3, 2023
(86) PCT No.: PCT/US2023/078650

§ 371 Date: May 2, 2025

Related U.S. Application Data
(60) Provisional application No. 63/422,522, filed on Nov. 4, 2022.

(51) Int. Cl. H04B 1/7183; H04B 1/40; H04B 1/7163; H04B 1/719

(52) U.S. Cl. CPC H04B 1/7183; H04B 1/40; H04B 1/7163; H04B 1/71637; H04B 1/719

(57) ABSTRACT

Systems, methods and apparatus for ultra-wideband (UWB) transmissions are provided. An electronic device may include a digital phase-locked loop (PLL) configured to output a clock signal, a high-pass filter configured to receive the clock signal and convert the clock signal into a baseband impulse signal, and a bandwidth expansion circuit configured to receive the baseband impulse signal and convert the baseband impulse signal into an expanded bandwidth impulse signal. An uppermost frequency of the expanded bandwidth impulse signal may be greater than an uppermost frequency of the baseband impulse signal.

### CROSS-REFERENCE TO RELATED APPLICATION

This application claims priority to U.S. Provisional Application Ser. No. 63/422,522 entitled SYSTEMS, METHODS AND APPARATUS FOR HIGH ACCURACY TRACKING WITH ULTRA LOW POWER WIRELESS TAGS, filed in the USPTO on Nov. 4, 2022, the disclosure of which is hereby incorporated by reference herein in its entirety.

### BACKGROUND

The present disclosure generally relates to systems, methods and apparatus for ultra-wideband (UWB) transmissions.

With the recent increase in popularity of active UWB tracking beacons, the next era of low-power Internet of Things (IoT) aims to offer tracking as a core feature in numerous enterprise and industrial applications. However, generating high-bandwidth tracking signals on cost-efficient, low-power tags poses challenges in energy versus cost performance trade-offs.

In recent years, there have been advances in physical IoT, where everyday objects and devices (e.g., cameras, refrigerators, water sensors, locks, etc.) are connected to the Internet to enable increased convenience and utility for consumers. The next generation of physical IoT aims to go beyond connectivity and embed tracking as a core feature in dynamic devices (e.g., glasses, speakers, cameras, etc.) to derive more value out of these applications.

While these advances will continue to evolve on the consumer front, delivering IoT's value of increased efficiencies and productivity on larger scales (e.g., for enterprises, factories, supply chains, etc.) that is both affordable (low-cost) and sustainable (ultra-low power for extended lifetime) presents numerous design challenges.

### SUMMARY

According to some embodiments of the present disclosure, an electronic device may include a digital phase-locked loop (PLL) configured to output a clock signal, a high-pass filter configured to receive the clock signal and convert the clock signal into a baseband impulse signal, and a bandwidth expansion circuit configured to receive the baseband impulse signal and convert the baseband impulse signal into an expanded bandwidth impulse signal. An uppermost frequency of the expanded bandwidth impulse signal may be greater than an uppermost frequency of the baseband impulse signal.

According to some embodiments of the present disclosure, a wireless tag device may include a phase modulator configured to receive RF impulse signals and convert the RF impulse signals into UWB preamble signals. The wireless tag device may be configured to output the UWB preamble signals in a sequence and time-vary a position of ones of the UWB preamble signals in the sequence, thereby creating a signature for the UWB preamble signals that corresponds to the wireless tag device.

According to some embodiments of the present disclosure, an electronic device may include a digital PLL configured to output a clock signal having a frequency of 31.2 MHz, and an RF impulse generation circuit configured to up-convert the frequency of the clock signal and generate an RF impulse signal.

According to some embodiments of the present disclosure, a method of generating a UWB signal may include outputting a clock signal from a digital PLL, converting the clock signal into a baseband impulse signal by passing the clock signal through a high-pass filter, and converting the baseband impulse signal into an expanded bandwidth impulse signal by passing the baseband impulse signal through a bandwidth expansion circuit. An uppermost frequency of the expanded bandwidth impulse signal may be greater than an uppermost frequency of the baseband impulse signal.

According to some embodiments of the present disclosure, a method of split-phase modulation may include outputting a clock signal from a digital PLL, the clock signal including rising and falling edges, converting the clock signal into a baseband impulse signal by passing the clock signal through a high-pass filter, the baseband impulse signal including positive impulses corresponding to the rising edges of the clock signal, respectively, and negative impulses corresponding to the falling edges of the clock signal, respectively, and performing a phase consistency operation by selecting the positive impulses and ignoring the negative impulses.

### BRIEF DESCRIPTION OF THE DRAWINGS

The accompanying drawings, which are incorporated in and constitute a part of the specification, illustrate embodiments of the inventive concepts and, together with the description, serve to explain principles of the inventive concepts.

FIG. 1 is a schematic diagram of an ultra-wideband transmission according to some embodiments.

FIG. 2 is a block diagram of an electronic device of FIG. 1 according to some embodiments.

FIG. 3 is a block diagram of a digital PLL and an RF impulse generation circuit of FIG. 2 according to some embodiments.

FIG. 4 is a schematic circuit diagram of a bandwidth expansion circuit of FIG. 3 according to some embodiments.

FIG. 5 is a schematic diagram of a frequency response of a bandwidth expansion circuit of FIGS. 3 and 4 according to some embodiments.

FIG. 6 is schematic diagram of a phase modulator of FIG. 2 according to some embodiments.

FIG. 7 is a schematic diagram of a preamble position coding operation according to some embodiments.

FIG. 8 is a flow chart of methods of generating an ultra-wideband signal according to some embodiments.

FIG. 9 is a flow chart of methods of split-phase modulation according to some embodiments.

FIG. 10 is a schematic diagram of an example use case for an electronic device according to some embodiments.

### DETAILED DESCRIPTION

Various aspects of the present disclosure are directed to systems, methods and apparatus for ultra-wideband (UWB) transmissions. For example, various aspects of the present disclosure are directed to systems, methods and apparatus for wireless tag tracking using UWB transmissions.

The present disclosure is described herein with reference to the accompanying drawings and examples, in which embodiments are shown. Additional embodiments may take on many different forms and should not be construed as limited to the embodiments set forth herein. Rather, these embodiments are provided so that this disclosure will be thorough and complete, and will fully convey the scope of the present disclosure to those skilled in the art.

The terminology used herein is for the purpose of describing particular embodiments only and is not intended to be limiting thereof. As used herein, the singular forms “a,” “an” and “the” are intended to include the plural forms as well, unless the context clearly indicates otherwise. It will be further understood that the terms “comprises,” “comprising,” “includes,” “including,” “has,” “having” and any other variations thereof when used in this specification, specify the presence of the stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under.” The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims, description, or figures unless specifically indicated otherwise.

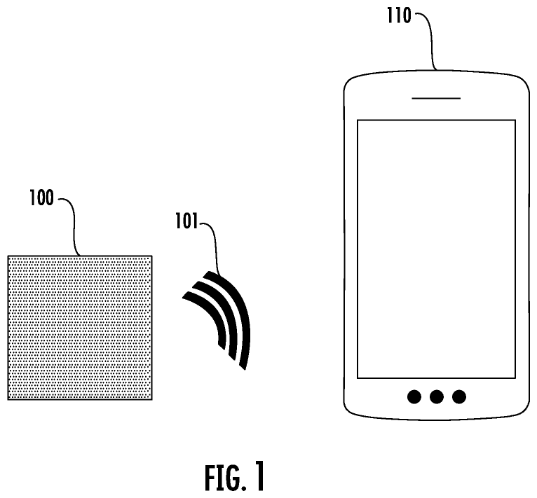

FIG. 1 is a schematic diagram of an ultra-wideband (UWB) transmission according to some embodiments.

Referring to FIG. 1, an electronic device 100 (which may be a wireless tracking tag) may be designed to support ultra-wideband (UWB) transmissions. The electronic device 100 may include a UWB transmitter. For example, the electronic device 100 may transmit a UWB signal 101 to a commodity device 110 (also referred to as an anchor or a UWB receiver).

The UWB signal 101 may be an industry standards compliant UWB preamble signal having a frequency corresponding to an operating frequency of a UWB channel. The UWB standard is based on IEEE 802.15.4, and the UWB preamble signal may be within a wide frequency range from 3.1 Gigahertz (GHz) to 10.6 GHz. UWB channels may have bandwidths of, for example, close to or greater than 500 Megahertz (MHz).

The commodity device 110 may include a UWB receiver that receives the UWB signal 101. For example, the commodity device 110 may include a UWB integrated circuit chip having a UWB receiver. While FIG. 1 illustrates that the commodity device 110 is a mobile device, the present disclosure is not limited thereto. For example, the commodity device 110 may be any device capable of receiving UWB transmissions such as, for example, access points, computers, etc.

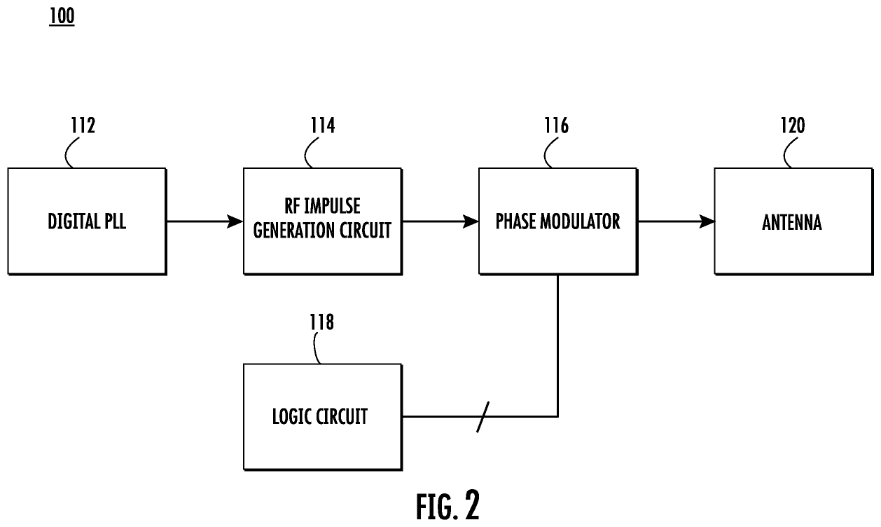

FIG. 2 is a block diagram of the electronic device 100 of FIG. 1 according to some embodiments.

Referring to FIG. 2, the electronic device 100 may include a digital phase-locked loop (PLL) 112 (also referred to as a digital PLL circuit), a radio frequency (RF) impulse generation circuit 114, a phase modulator 116 (also referred to as a phase modulator circuit), a logic circuit 118, and an antenna 120.

The digital PLL 112 may output a clock signal. The digital PLL 112 may include one or more logic elements and may operate at low frequencies (e.g., less than 100 MHz). The digital PLL 112 may thus operate in a desired energy-interoperability region. For example, the digital PLL 112 may generate a clock signal with high phase accuracy (e.g., less than 100 picoseconds (ps) jitter), at a reduced energy cost (e.g., less than 1 nanojoules (nJ)/packet), and reduced time to settle (e.g., less than one millisecond (ms)), as compared to an RF PLL. The digital PLL 112 may strike an efficient balance between phase fidelity and energy consumption for the electronic device 100. The digital PLL 112 may be able to be heavily duty-cycled, while being able to produce a low jitter clock signal. The digital PLL 112 may generate a clock signal at a low frequency of less than 100 MHz.

The RF impulse generation circuit 114 may receive the clock signal output from the digital PLL 112, up-convert a frequency of the clock signal, and generate an RF impulse signal. With the digital PLL 112 operating at low frequencies, simply employing the digital PLL 112 as part of an existing UWB design may not suffice. The RF impulse generation circuit 114 may up-convert the clock signal output by the digital PLL 112 to much higher target RF frequencies (e.g., greater than 3 GHz). The RF impulse generation circuit 114 may perform the frequency up-conversion of the clock signal, and may also ensure that conversion of the clock signal to the RF impulse signal is accomplished at low energy footprints, while preserving the low jitter characteristics of the clock signal.

The RF impulse generation circuit 114 may facilitate generating UWB signals at super high frequencies directly from the output of the digital PLL 112, without actively generating the RF carrier signal. For example, the electronic device 100 may leverage the digital PLL 112 and transform its low frequency, high fidelity clock signal to UWB signals at desired super high frequencies (e.g., within the 3.1-10.6 GHz frequency range) without compromising on its low energy footprint. The RF impulse generation circuit 114 may enable the electronic device 100 to be a carrier-generating design, and the electronic device 100 may thus not incur the limitations of external device dependence. That is, the electronic device 100 may not rely on an external device to generate an RF carrier, which may reduce deployment costs, increase practicability, and/or reduce energy consumption of the electronic device 100.

The phase modulator 116 may receive the RF impulse signal output from the RF impulse generation circuit 114 and convert the RF impulse signal into a UWB preamble signal. The phase modulator 116 may perform phase-shift keying on the RF impulse signal. For example, the phase modulator 116 may perform binary phase-shift keying (BPSK) on the RF impulse signal. The phase modulator 116 may be a passive delay-based circuit that imparts binary phase modulation to the RF impulse signal.

The logic circuit 118 may control an operation of the phase modulator 116. For example, the logic circuit 118 may control an operation of the phase modulator 116 to generate the UWB preamble signal. The logic circuit 118 may also duty-cycle the clock signal output by the digital PLL 112 and may sharpen edges of the clock signal to reduce the time of rising edge(s) and/or falling edge(s) thereof. The logic circuit 118 may include any appropriate processing circuitry. For example, the logic circuit 118 may include a complex programmable logic device (CPLD), but is not limited thereto.

The antenna 120 may receive the UWB preamble signal output from the phase modulator 116 and transmit the UWB preamble signal to a UWB receiver. For example, the antenna 120 may provide 2-3 db antenna gain across various directions, but is not limited thereto. In some embodiments, the UWB preamble signals may be continuously transmitted via the antenna 120.

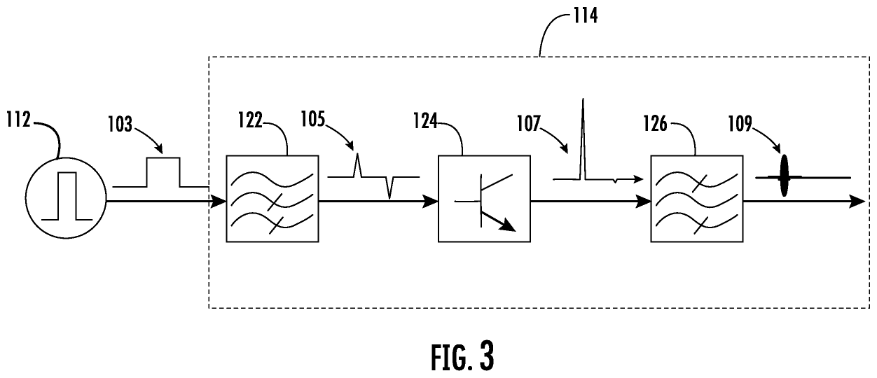

FIG. 3 is a block diagram of the digital PLL 112 and the RF impulse generation circuit 114 of FIG. 2 according to some embodiments.

Referring to FIG. 3, an output of the digital PLL 112 may be a clock signal 103. The clock signal 103 may be a square wave clock signal in example embodiments. A frequency of the clock signal 103 may be less than 100 MHz. The clock signal 103 output by the digital PLL 112 may be set to the pulse repetition frequency (PRF) of UWB channels. In some embodiments, the clock signal 103 may have a frequency of 31.2 MHz. For example, the clock signal 103 generated by the digital PLL 112 may have less than 100 ps jitter, less than 1 nJ/packet, and less than one ms time to settle.

The RF impulse generation circuit 114 may include a high-pass filter 122 (HPF), a bandwidth expansion circuit 124, and a band-pass filter 126 (BPF).

The high-pass filter 122 may receive the clock signal 103 output from the digital PLL 112 and convert the clock signal 103 into a baseband impulse signal 105. The baseband impulse signal 105 may include an impulse that has a narrow pulse width (e.g., less than 1 nanosecond (ns) width), whose frequency may span from DC to sub-GHz. For example, the baseband impulse signal 105 may be within a portion of a frequency range that spans from 0 Hz to less than 1 GHz.

The digital clock signal 103 may be converted to narrow baseband impulses at little to no additional energy cost because, when a square wave is passed through the high-pass filter 122, the square wave's rising and falling edges may be converted to positive and negative impulses, respectively. Also, the resulting width of the impulses may be determined by the rise and fall time of the square wave's edges. Hence, narrow impulses may be produced by the high-pass filter 122, and the baseband impulse signal 105 may include the narrow impulses. The resulting pulse width(s) of the baseband impulse signal 105 and its frequency spectrum may comply with the UWB standard (e.g., based on IEEE 802.15.4). In some embodiments, the high-pass filter 122 may be a passive high-pass filter formed using resistors, capacitors, and/or inductors. The baseband impulse signal 105 may include a plurality of impulses. As used herein, impulses included in the baseband impulse signal 105 may also be referred to as baseband impulses. As used herein, an “impulse” may also be referred to as a “pulse” and vice-versa.

Impulses with the same phase may be produced using the portion of the baseband impulse signal 105 that corresponds to rising edges of the clock signal 103 while ignoring the portion of the baseband impulse signal 105 that corresponds to falling edges of the clock signal 103. For example, the baseband impulse signal 105 may include at least one positive impulse having a positive amplitude and at least one negative impulse having a negative amplitude. The positive impulse may correspond to a rising edge of the clock signal 103, and the negative impulse may correspond to a falling edge of the clock signal 103. The electronic device 100 may perform a phase consistency operation by selecting the positive impulse(s) and ignoring (e.g., discarding) the negative impulse(s). For example, the electronic device 100 may use the positive impulse(s) to maintain consistent ‘positive’ amplitude of the impulses.

The bandwidth expansion circuit 124 may receive the baseband impulse signal 105 and convert the baseband impulse signal 105 into an expanded bandwidth impulse signal 107. For example, the bandwidth expansion circuit 124 may receive the baseband impulse signal 105 and expand a bandwidth of the baseband impulse signal 105 such that the baseband impulse signal 105 is converted into the expanded bandwidth impulse signal 107. The expanded bandwidth impulse signal 107 may be within a portion of a frequency range that spans from 0 Hz to greater than 10 GHz. The bandwidth (i.e., frequency range) of the expanded bandwidth impulse signal 107 may be expanded so as to encompass a target UWB channel. For example, the target UWB channel may be included within a portion of a 3.1 GHz to 10.6 GHz frequency range.

The baseband impulse signal 105 may serve as input to the bandwidth expansion circuit 124 to duty-cycle an active power of the bandwidth expansion circuit 124, thereby reducing a power consumption of the electronic device 100. That is, the baseband impulse signal 105 may be used to directly trigger and drive the bandwidth expansion circuit 124, which may reduce energy consumption. Impulses included in the baseband impulse signal 105 may have a narrow width as well as a large amplitude for turning on the bandwidth expansion circuit 124 for a small fraction of time, thereby reducing power consumption.

The bandwidth expansion circuit 124 may be non-linear and may include a two-stage bipolar junction transistor (BJT) circuit. The bandwidth expansion circuit 124 may convert the baseband impulse signal 105, in frequency domain, into the expanded bandwidth impulse signal 107. For example, the baseband impulse signal 105 may be a voltage impulse signal, and the expanded bandwidth impulse signal 107 may be a frequency-expanded current impulse signal.

An uppermost frequency of the expanded bandwidth impulse signal 107 may be greater than an uppermost frequency of the baseband impulse signal 105. In some embodiments, the uppermost frequency of the baseband impulse signal 105 may be less than 1 GHz, and the uppermost frequency of the expanded bandwidth impulse signal 107 may be greater than or equal to 3.1 GHz. For example, the uppermost frequency of the expanded bandwidth impulse signal 107 may be greater than or equal to 3.75 GHz. 3.75 GHz may be a maximum frequency of a first (e.g., leftmost) UWB channel in the low half of the UWB frequency band. In some embodiments, the uppermost frequency of the expanded bandwidth impulse signal 107 may be greater than 10 GHz, so that it may encompass every UWB channel.

The high-pass filter 122 followed by the bandwidth expansion circuit 124 may allow for up-conversion of the clock signal 103 to RF impulses corresponding to the UWB frequency range, and the narrow baseband impulse signal 105 may be used to trigger the bandwidth expansion circuit 124. This may extend the frequency response of the baseband impulse signal 105 to much wider frequency ranges when converted into the expanded bandwidth impulse signal 107, so as to include a target UWB channel. Such frequency expansion may allow for selection of the portion of the frequency domain that contains the target UWB channel using the band-pass filter 126. For example, the bandwidth expansion circuit 124 may be an impulse frequency expansion circuit that wastes minimal energy while turned off, which may allow the electronic device 100 to save significant energy when the bandwidth expansion circuit 124 is duty-cycled by the baseband impulse signal 105.

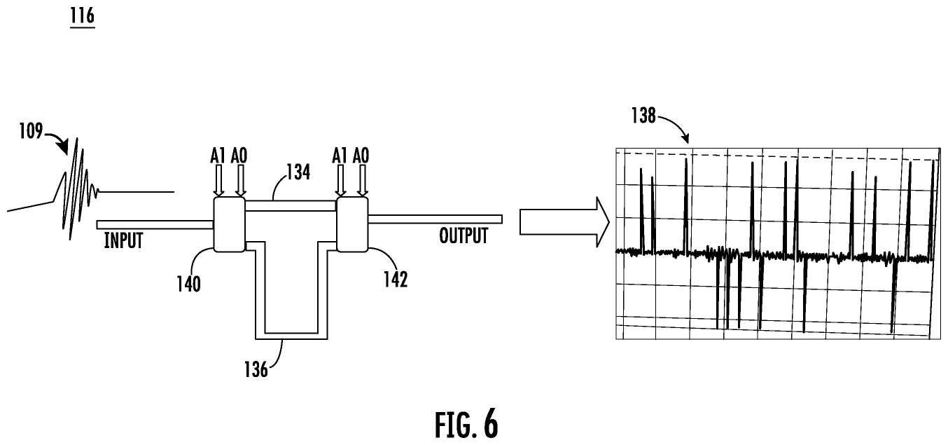

The band-pass filter 126 may receive the expanded bandwidth impulse signal 107 and convert the expanded bandwidth impulse signal 107 into an RF impulse signal 109. For example, a last stage in the RF impulse generation circuit 114 may be the isolation of the RF impulse signal 109 at a target frequency. The band-pass filter may convert the expanded bandwidth impulse signal 107 into the RF impulse signal 109, which is isolated in a target frequency range. The target frequency range may correspond to an operating frequency of a target UWB channel. The RF impulse signal 109 may thus have a frequency that corresponds to an operating frequency of the target UWB channel. The RF impulse signal 109 may include a sequence of impulses with a same phase. As used herein, impulses included in the RF impulse signal 109 may also be referred to as RF impulses. The RF impulses may have a frequency that is within a UWB frequency range (e.g., 3.1 to 10.6 GHz). In other words, a frequency of the RF impulse signal 109 may be within a portion of a 3.1-10.6 GHz frequency range. The RF impulses included in the RF impulse signal 109 may be modulated and converted into a UWB preamble signal 138 to be described later with reference to FIG. 6.

The band-pass filter 126 may have a passband that is within a portion of a 3.1-10.6 GHz frequency range. In some embodiments, the band-pass filter 126 may be omitted, and the expanded bandwidth impulse signal 107 may be output from the RF impulse generation circuit 114 to the phase modulator 116 (see FIG. 2). The frequency spectrum of the expanded bandwidth impulse signal 107 may be flat across the UWB band, including the target UWB channel, which may allow for the use of the band-pass filter 126 having a passband matching the target UWB channel. This may nullify power over the entire spectrum except for the target UWB channel. The passband of the band-pass filter 126 may be compliant with power spectral density requirements of the UWB standard. The resulting RF impulse signal 109 may include RF impulse(s) at a frequency of the target UWB channel.

FIG. 3 illustrates an example RF impulse signal 109 at the output of the band-pass filter 126 in frequency domain. It may also be expressed in the time domain as, P(t)=A(t)e^{jφ}^{ₛ}^{(t)}e^{j2πf}^{_{c}}^{t}, where e^{j2πf}^{_{c}}^{t} is the fast-varying carrier signal at the target UWB channel frequency f_{c}. Also, A(t) is the pulse amplitude, and φₛ(t) is the slow-varying phase of the carrier. The slow variation may enable robust preamble decoding by UWB receivers.

The RF impulse signal 109 may be delivered at low power, yet strong enough to provide reasonable coverage for a practical tracking solution. The average power drawn from a DC power supply powering the circuit of FIG. 3 may be

$${P}_{ave} = \frac{1}{T} {V}_{cc} {\int }_{T} {1}_{{C}_{2}} ( t ) dt .$$

The drawn power may be almost evenly distributed across the frequency range between DC and f′_{3 dB}.

$$\frac{{BW}_{BPF}}{{f}_{3 d B}^{′}}$$

of this power may belong to the target UWB channel, which may be equivalent to the passband of the band-pass filter (BPF) 126. The power at the output of the band-pass filter 126 may be

$${P}_{out} = [ \frac{1}{T} {V}_{cc} {\int }_{T} {I}_{{c}_{2}} ( t ) dt ] \times \frac{{BW}_{BPE}}{{f}_{3 d B}^{′}} \times {IL}_{BPF} ,$$

where IL_{BPF} is the insertion loss of the band-pass filter 126.

To analyze the phase consistency of produced impulses at UWB frequencies included in the RF impulse signal 109, two adjacent impulses included in the RF impulse signal 109 that are produced by two adjacent baseband impulses (i.e., two consecutive positive/rising clock edges passed through the high-pass filter 122) included in the baseband impulse signal 105 may be considered. In this case, the first impulse can be expressed as A(t)e^{jφ}^{ₛ}^{(t)}e^{j2πf}^{_{c}}^{t}, and the second impulse can be expressed as A(t+T)e^{jφ}^{ₛ}^{(t+T)}e^{j2πf}^{_{c}}^{(t+T)}, where T=1/PRF is the cycle period of the clock signal 103. PRF may be the pulse repetition frequency of the clock signal 103. Owing to the periodicity of the baseband impulse(s) included in the baseband impulse signal 105 that triggers the input of the bandwidth expansion circuit 124, A(t)=A(t+T), and φs(t)=φs(t+T). In other words, the amplitude and the slow varying phase terms may be equal for the two consecutively produced impulses included in the RF impulse signal 109. In addition, since 2πfcT=2πN (where N is an integer number) this may imply that e^{j2πf}^{_{c}}^{(t+T)}e^{j2πf}^{_{c}}^{t}. Thus, an output of the RF impulse generation circuit 114 may be equivalent to a UWB transmitter that mixes the baseband impulses included in the baseband impulse signal 105 with a continuous wave carrier having constant phase and frequency.

In some embodiments, the RF impulse generation circuit 114 may produce the RF impulse signal 109 including at least one RF impulse at a frequency of a target UWB channel directly from the low frequency clock signal 103 generated by the digital PLL 112. The RF impulse signal 109 may be produced without using any local PLL or oscillator operating at super high frequencies (e.g., greater than or equal to 3 GHz). Consequently, the electronic device 100 may not include an RF oscillator and may not include an RF PLL. That is, the electronic device 100 may be free of an RF oscillator and an RF PLL. This may significantly scale down the energy requirement for producing RF impulses at sufficient transmit power. In some embodiments, the electronic device 100 may be an ultra-low power UWB transmitter design that is compliant with commercial UWB receivers and can enable robust localization with no additional infrastructure requirements.

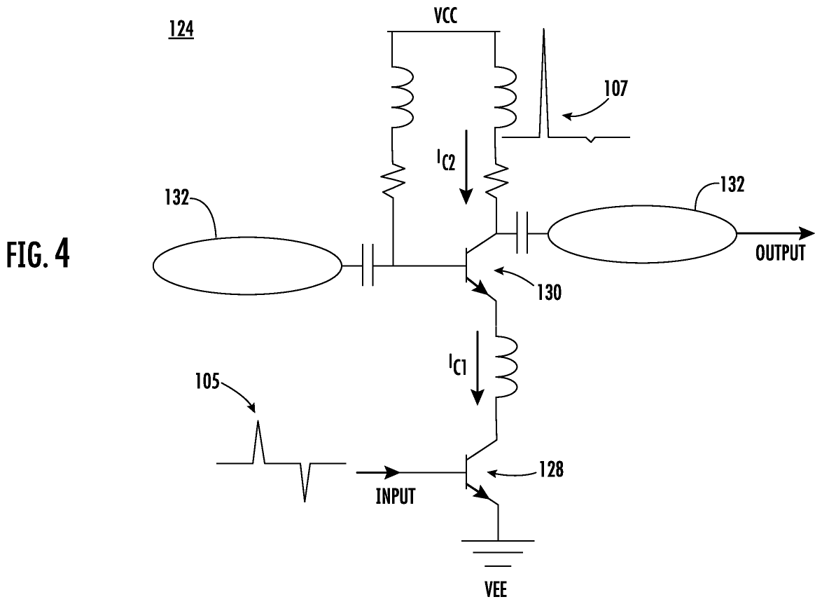

FIG. 4 is a schematic circuit diagram of the bandwidth expansion circuit 124 of FIG. 3 according to some embodiments.

Referring to FIG. 4, the bandwidth expansion circuit 124 may include first and second cascaded transistors 128 and 130 (also referred to as a cascode amplifier or a two-stage amplifier). The first and second transistors 128 and 130 may be BJTs. The first and second transistors 128 and 130 may be used as a non-linear device for frequency expansion because the exponential relation between collector current and voltage at the base-emitter terminal (hereinafter, referred to as “the exponential effect”) of a BJT may be

$${I}_{s} = {I}_{s} \cdot {e}^{\frac{{V}_{BE} - {V}_{th}}{{nV}_{T}}} ,$$

where Iₛ, Vₜₕ, n, and V_{T} are constants which may be determined by the dimensions as well as other physical aspects of the first and second transistors 128 and 130. As a result, when the base-emitter terminal of the first transistor 128 is driven by the baseband impulse signal 105, a first collector current I_{c1} may also be an impulse signal of much smaller width (e.g., a much sharper signal) owing to the exponential effect that is responsible for bandwidth expansion. This may further be transferred to a second collector current I_{c2}, as the first collector current I_{c1} serves as the emitter current for the second transistor 130 and

$${I}_{c 2} = \frac{β}{β + 1} \times {I}_{c 1} ,$$

where β is a transistor-dependent constant. The width of the baseband impulse signal 105 in the time domain may have an inverse relationship with the width of the frequency spectrum spanned by the baseband impulse signal 105. Thus, as the baseband impulse signal 105 is converted to the expanded bandwidth impulse signal 107 having a much narrower pulse width, the expanded bandwidth impulse signal 107 is expanded to higher frequency ranges.

The bandwidth expansion circuit 124 may be a non-linear circuit including the two-stage cascade of the first and second transistors 128 and 130. The two-stage cascade of the first and second transistors 128 and 130 may expand the bandwidth of the baseband impulse signal 105 by converting the baseband impulse signal 105 into the expanded bandwidth impulse signal 107. The baseband impulse signal 105 may directly trigger and drive the bandwidth expansion circuit 124.

The bandwidth expansion circuit 124 may also include RF matching circuits 132. One RF matching circuit 132 may be provided at an output of the bandwidth expansion circuit 124, which may be connected to the band-pass filter 126 (see FIG. 3). Another RF matching circuit 132 may be provided opposite to the output of the bandwidth expansion circuit 124, which may be another RF path. The RF matching circuits 132 may include inductor and capacitor (LC) components and may thus incur minimal loss. The RF matching circuits 132 may optimize power transfer (e.g., gain) of the expanded bandwidth impulse signal 107 by impedance matching the input and output of the bandwidth expansion circuit 124 to its connections to other circuit elements. For example, the RF matching circuits 132 may increase a gain of the of the expanded bandwidth impulse signal 107 output from the bandwidth expansion circuit 124. The RF matching circuits 132 may reduce power loss in the bandwidth expansion circuit 124 when converting the baseband impulse signal 105 into the expanded bandwidth impulse signal 107. The expanded bandwidth impulse signal 107 may be output from the bandwidth expansion circuit 124 to the band-pass filter 126. The band-pass filter 126 may receive the expanded bandwidth impulse signal 107 from the RF matching circuit 132 at the output of the bandwidth expansion circuit 124.

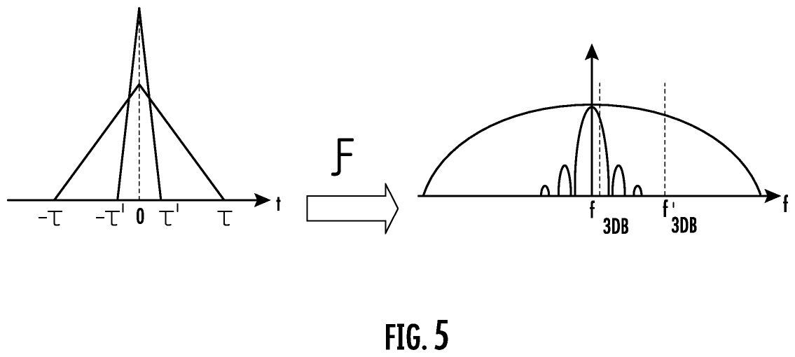

FIG. 5 is a schematic diagram of a frequency response of the bandwidth expansion circuit 124 of FIGS. 3 and 4 according to some embodiments. In particular, FIG. 5 illustrates an input/output triangular approximation of the extent of bandwidth expansion when converting the baseband impulse signal 105 into the expanded bandwidth impulse signal 107.

Referring to FIGS. 3 to 5, an approximation may be performed of both the input baseband impulse signal 105 and the output expanded bandwidth impulse signal 107 with triangular pulses. The baseband impulse signal 105 may be a voltage impulse signal that is output from the high-pass filter 122, and the expanded bandwidth impulse signal 107 may be a current impulse signal that is output from the bandwidth expansion circuit 124.

As shown in FIG. 5, the frequency response (i.e., Fourier transform) of a triangular pulse with width 2τ (i.e., magnitude becomes zero at −τ and +τ) may be the square of the Sinc(·) function: τSinc²(πτf). To compare the frequency response of the input baseband impulse signal 105 (i.e., a voltage impulse) with that of the output expanded bandwidth impulse signal 107 (i.e., a current impulse), the 3 dB bandwidths of each signal may be considered, i.e., the frequency at which the magnitude of the frequency response is 3 dB below the magnitude at DC. Denoting the 3 dB bandwidth as f_{3 dB}, Sinc² (πτf3 dB)=\sqrt{2}. Hence,

$${f}_{3 d B} = \frac{{Sinc}^{- 1} ( \sqrt[4]{2} )}{πτ} ,$$

where Sinc⁻¹(·) is the inverse of the Sinc(·) function (for the interval

$$( \frac{- 1}{τ} , \frac{1}{τ} )$$

over which the function Sinc(·) is invertible). Thus, the ratio between the 3 dB bandwidths of the output expanded bandwidth impulse signal 107 and the input baseband impulse signal 105 may be the inverse of the ratio between their pulse widths, i.e.,

$$\frac{{f}_{3 d B}^{′}}{{f}_{d B}^{3}} = \frac{τ}{{τ}^{′}} ,$$

where τ and τ′ correspond to when the magnitude of the triangular pulse approximation of the input and output reaches zero. To calculate

$$\frac{τ}{{τ}^{′}}$$

the time it takes for the approximated triangular pulses to reach 10% of their maximum may be considered. These times are denoted by τ₁₀ and τ′₁₀ for the input and output, respectively. This may be done for two reasons:

$$\frac{{τ}_{10}}{{τ}_{10}^{′}} = \frac{τ}{{τ}^{′}} ; \qquad ( i )$$

and (ii) the triangular approximation may deviate from the real value after the 10% value, especially for the output expanded bandwidth impulse signal 107. Hence, τ and τ′ may not be directly extrapolated by equating the magnitude to zero. Instead, τ₁₀ and τ′₁₀ may be extrapolated by equating the magnitude to 10% of its peak. When estimating

$$\frac{{τ}_{10}}{{τ}_{10}^{′}}$$

to using extrapolation, for the input baseband impulse signal 105, the triangular approximation may be expressed as

$$V ( t ) = {V}_{m} ( 1 - \frac{t}{τ} ) for t > 0 ,$$

where, Vₘ is the peak voltage at t=0. Therefore, solving the linear equation for V(τ₁₀)=0.1Vₘ yields τ₁₀=0.9τ. On the other hand, for the output expanded bandwidth impulse signal 107, the formula for exponential effect discussed with reference to FIG. 4 may be used instead of the triangular approximation, since the resulting values are extremely close to each other:

$$I ( t ) = α \cdot {I}_{s} \cdot {e}^{\frac{V ( t ) - {V}_{th}}{{nV}_{T}}} .$$

Given a definition of τ′₁₀, I(τ′₁₀)=0.1 I(0). Hence,

$${e}^{\frac{V ( {τ}_{10}^{′} ) - {V}_{th}}{{nV}_{T}}} = 0.1 {e}^{\frac{{V}_{m} - {V}_{th}}{{nV}_{T}}} .$$

Solving the above equation, V(τ′₁₀)=Vₘ−nV_{T} ln 10. Thus, if the above result is incorporated with the triangular approximation of the baseband impulse signal 105, i.e.,

$$V ( t ) = {V}_{m} ( 1 - \frac{t}{τ} ) , then {τ}_{10}^{′} = \frac{{nV}_{T} ( ln 10 ) τ}{{V}_{m}} .$$

### Hence,

$${ϵ}_{BW} = \frac{{f}_{3 d B}^{′}}{{f}_{3 d B}} \approx \frac{{τ}_{15}}{{τ}_{10}^{′}} \approx \frac{0.9 {V}_{m}}{{nV}_{T} ln 10} ,$$

where ε_{BW} is a bandwidth expansion factor of the bandwidth expansion circuit 124. The bandwidth expansion factor ε_{BW} is largely controlled by Vₘ. While a Vₘ less than 0.7 V may not trigger the first and second transistors 128 and 130, too large of a Vₘ may saturate the first and second transistors 128 and 130, while also spreading and wasting energy over a larger spectrum than may be needed. Hence, Vₘ=0.75 V may be selected, which along with nV_{T}=25 mV for the first and second transistors 128 and 130 results in ε_{BW}≈11.7, extending the 3 dB bandwidth from 1 GHz to over 10 GHz. The bandwidth expansion circuit 124 may thus output the expanded bandwidth impulse signal 107 having an uppermost frequency that is greater than 10 GHz.

FIG. 6 is schematic diagram of the phase modulator 116 of FIG. 2 according to some embodiments.

Referring to FIGS. 2, 3, and 6, the phase modulator 116 may receive the RF impulse signal 109 and convert the RF impulse signal 109 into a UWB preamble signal 138. For example, the UWB preamble signal 138 may be a minimal information unit that enables localization with a UWB receiver. The UWB preamble signal 138 may include impulses that are binary modulated in amplitude and/or phase, namely a sequence of positive (phase=0°, amplitude=1), negative (phase=180°, amplitude=1), and/or null (amplitude=0) impulses at a fixed rate referred to as a pulse repetition frequency (PRF). While the UWB standard defines a few values for the PRF of the preamble, a PRF of 31.2 MHz may be used by many UWB receivers. The UWB preamble signal 138 may correspond to the UWB signal 101 of FIG. 1.

A standard UWB packet may begin with a preamble that consists of a known sequence of positive (+), negative (−), and/or null impulses (e.g., defined in the UWB standard based on IEEE 802.15.4) at a fixed PRF. This may require control over the phase of the RF impulses included in the RF impulse signal 109 so as to preserve the low jitter of the clock signal 103 generated by the digital PLL 112 through frequency up-conversion in the RF impulse generation circuit 114. In other words, the phase of the generated RF impulses included in the RF impulse signal 109 may be consistent (e.g., substantially the same) with each other. The RF impulses included in the RF impulse signal 109 may resemble a continuous wave RF carrier with a fixed phase and frequency (matching the target UWB channel) that is multiplied with positive, negative, and null impulses, thereby creating the UWB preamble signal 138. If this is not the case, commercial UWB receivers may fail to decode the UWB preamble signal 138 correctly as some of the UWB impulses included in the UWB preamble signal 138 may flip in sign arbitrarily after demodulation at the UWB receiver. As used herein, impulses included in the UWB preamble signal 138 may also be referred to as UWB impulses.

In some designs, impulses included in the baseband impulse signal 105 may be first phase modulated at baseband and then mixed with a local carrier for frequency up-conversion to the UWB band (e.g., 3.1-10.6 GHz). However, modulation at baseband may not be favorable for two reasons. First, the mixer-based approach may mix the baseband carrier with a locally generated carrier, which may be energy-intensive. Second, the negative baseband impulses, which may correspond to falling edges of the clock signal 103, may not be able to trigger the bandwidth expansion circuit 124 to produce the RF impulses at super high frequencies included in the RF impulse signal 109.

In some embodiments, the electronic device 100 may adopt a split-phase modulation approach, whereby first, baseband impulses with the same phase included in the baseband impulse signal 105 may be produced using the clock signal's 103 rising edges (i.e., positive impulses), while ignoring the negative impulses produced using the clock signal's 103 falling edges, and then the phase of at least one RF impulse included in the RF impulse signal 109 may be shifted by 180° by the phase modulator 116 to generate negative impulse(s) included in the UWB preamble signal 138 at super high frequencies (e.g., greater than 3 GHz).

The phase of the RF impulses included in the RF impulse signal 109 may be consistent (e.g., substantially the same) before they pass through the phase modulator 116. This condition may be met by leveraging the fact that the carrier frequency of every target UWB channel may be an integer multiplier of the PRF=31.2 MHz. For example, setting the clock signal 103 of the digital PLL 112 to the PRF of UWB channels (e.g., 31.2 MHz) may allow for impulses generated at integer multiples of the frequency of target UWB channels. In some embodiments, baseband impulses with a same phase may be produced using the clock signal's 103 rising edges (i.e., positive impulses), while ignoring the negative impulses produced using the clock signal's 103 falling edges. In some embodiments, the clock signal 103 may have a frequency of 31.2 MHz, and the RF impulses included in the RF impulse signal 109 may have a much higher frequency that is a multiple of the 31.2 MHz frequency. The RF impulses included in the RF impulse signal 109 may have a frequency that is within a portion of a 3.1-10.6 GHz frequency range.

In addition, the phase error produced by this effect may be minimal if phase detection is relied on for localization of the electronic device 100. The electronic device 100 may shift the phase of a generated RF impulse included in the RF impulse signal 109 by 1800 to create a negative (−) impulse for the UWB preamble signal 138. The electronic device 100 may also generate a ‘no’ impulse (null) for the UWB preamble signal 138. The UWB preamble signal 138 may include positive (+), negative (−), and/or null UWB impulses arranged in a sequence.

The split-phase modulation approach that delivers both low energy consumption and interoperability may be employed by the electronic device 100, whereby only phase consistency is imparted to the baseband impulse signal 105 (avoiding energy-expensive mixers needed for modulation), while the modulation itself is imparted later by the phase modulator 116 to the RF impulse signal 109 through a passive delay-based (e.g., varied length microstrips) circuit, thereby converting the RF impulse signal 109 into the UWB preamble signal 138. By splitting the phase modulation operation across baseband (phase consistency) and RF (modulation), the electronic device 100 may be able to ensure a low energy footprint. The first operation of the split-phase modulation approach may be referred to as a phase consistency operation, and the second operation of the split-phase modulation approach may be referred to as a phase modulation operation.

Referring to FIG. 6, the phase modulator 116 may perform the phase modulation operation of the split-phase modulation approach. The phase modulator 116 may perform phase shift keying on the RF impulse signal 109. For example, the phase modulator 116 may be a binary phase shift keying (BPSK) modulator. In converting a sequence of RF impulses with fixed phase at, for example, period T=1/PRF, the phase (to produce +/−impulses included in the UWB preamble signal 138) and amplitude (to produce null impulse(s) included in the UWB preamble signal 138) may both be modulated in a low power manner by the phase modulator 116 to convert the RF impulse signal 109 into the UWB preamble signal 138. Positive and negative UWB impulses included in the UWB preamble signal 138 may also be referred to as +/−impulses, respectively.

The phase modulator 116 may include first and second microstrip lines 134 and 136 with a length difference equal to half the wavelength of the carrier (e.g., a length difference equal to half the wavelength of the RF impulse signal 109). The phase modulator 116 may toggle (i.e., switch) between the first and second microstrip lines 134 and 136. The first microstrip line 134 may have a first length, and the second microstrip line 136 may have a second length greater than the first length. Thus, if an impulse included in the RF impulse signal 109 is passed through the second microstrip line 136, its phase may be shifted by 180° compared to when it is passed through the first microstrip line 134. The phase modulator 116, however, is not limited to the above design (e.g., including the first and second microstrip lines 134 and 136 with a length difference). For example, the phase modulator 116 may be any passive delay-based circuit capable of imparting binary phase modulation to the RF impulse signal 109.

The phase modulator 116 may also include first and second single pole double throw (SPDT) RF switches 140 and 142 that may connect an input of the phase modulator 116 to an output of the phase modulator 116 via either the first microstrip line 134 or the second microstrip line 136 depending on the value of control bits A0 and A1. The first SPDT switch 140 may connect the first microstrip line 134 or the second microstrip line 136 to the input of the phase modulator 116. The second SPDT switch 142 may connect the first microstrip line 134 or the second microstrip line 136 to the output of the phase modulator 116. For example, the first SPDT switch 140 may connect an RF impulse included in the RF impulse signal 109 to the first microstrip line 134 or the second microstrip line 136.

The first microstrip line 134 may be selected for sending a positive impulse to be included in the UWB preamble signal 138. For example, a positive impulse included in the UWB preamble signal 138 may correspond to one of the RF impulses included in the RF impulse signal 109 that passes through the first microstrip line 134. To select the first microstrip line 134, A0 may equal 1 and A1 may equal 0. The second microstrip line 136 may be selected for sending a negative impulse to be included in the UWB preamble signal 138. For example, a negative impulse included in the UWB preamble signal 138 may correspond to one of the RF impulses included in the RF impulse signal 109 that passes through the second microstrip line 136. To select the second microstrip line 136, A0 may equal 0 and A1 may equal 1.

The logic circuit 118 (see FIG. 2) may select the control bits A0 and A1. The logic circuit 118 may control an operation of the phase modulator 116 via the control bits A0 and A1. In addition, for amplitude modulation, the logic circuit 118 may block the clock signal 103 (see FIG. 3) at the input of the RF impulse generation circuit 114 (e.g., at the input of the high-pass filter 122). Thus, no impulse may appear at the output of the phase modulator 116 regardless of the values of the control bits A0 and A1, thereby creating a null impulse to be included in the UWB preamble signal 138. In other words, the logic circuit 118 may block the clock signal 103 at an input of the high-pass filter 122 such that an output of the phase modulator 116 corresponds to a null impulse. The UWB preamble signal 138 may include UWB impulses that are binary modulated in amplitude and/or phase, namely a sequence of positive (phase=0°, amplitude=1), negative (phase=180°, amplitude=1), and/or null (amplitude=0) impulses. The sequence of positive, negative, and/or null impulses included in the UWB preamble signal 138 may be fixed and predefined according to the UWB standard (e.g., based on IEEE 802.15.4).

FIG. 6 also illustrates an example snapshot of the industry standards-compliant UWB preamble signal 138 created at the output of the phase modulator 116. The UWB preamble signal 138 may be transmitted to a UWB receiver via the antenna 120 (see FIG. 2). In some embodiments, the UWB preamble signals 138 may be continuously transmitted via the antenna 120.

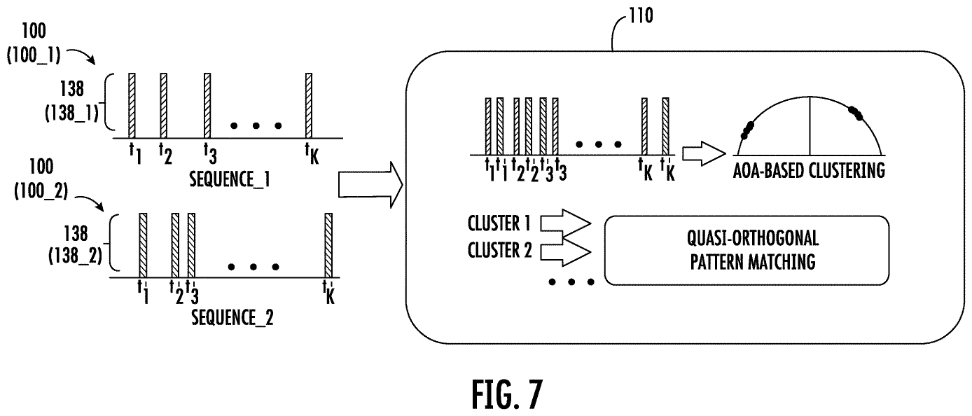

FIG. 7 is a schematic diagram of a preamble position coding (PPC) operation according to some embodiments. In particular, FIG. 7 illustrates a PPC operation of the electronic devices 100 to enable identification by the commodity device 110 and multiple access thereto.

Referring to FIG. 7, the electronic devices 100 may transmit the UWB preamble signals 138 to the commodity device 110. Each of the electronic devices 100 may include the phase modulator 116 described with reference to FIG. 6, and the phase modulator 116 may convert the RF impulse signals 109 into the UWB preamble signals 138. For example, a first electronic device 100_1 may transmit a plurality of first UWB preamble signals 138_1. The first electronic device 100_1 may output the first UWB preamble signals 138_1 in a first sequence Sequence_1. The first sequence Sequence_1 may be a sequence in which the first UWB preamble signals 138_1 are transmitted by the first electronic device 100_1. A second electronic device 100_2 may transmit a plurality of second UWB preamble signals 138_2. The second electronic device 100_2 may output the second UWB preamble signals 138_2 in a second sequence Sequence_2. The second sequence Sequence_2 may be a sequence in which the second UWB preamble signals 138_2 are transmitted by the second electronic device 100_2. The second electronic device 100_2 may be in a different location than the first electronic device 100_1.

The first electronic device 100_1 may time-vary a position of ones of the first UWB preamble signals 138_1 in the first sequence Sequence_1, thereby creating a signature for the first UWB preamble signals 138_1 that corresponds to the first electronic device 100_1. The signature may be a unique signature (e.g., unique with respect to a batch of electronic devices 100) that allows the commodity device 110 to identify that the first UWB preamble signals 138_1 are transmitted from the first electronic device 100_1. The signature for the first UWB preamble signals 138_1 may be encoded based on time differences between adjacent ones of the first UWB preamble signals 138_1 in the first sequence Sequence_1. The time differences between different pairs of the adjacent ones of the first UWB preamble signals 1381 in the first sequence Sequence_1 may vary.

The second electronic device 1002 may time-vary a position of ones of the second UWB preamble signals 138_2 in the second sequence Sequence_2, thereby creating a signature for the second UWB preamble signals 138_2 that corresponds to the second electronic device 100_2. The signature may be a unique signature that allows the commodity device 110 to identify that the second UWB preamble signals 138_2 are transmitted from the second electronic device 100_2. The signature for the second UWB preamble signals 138_2 may be encoded based on time differences between adjacent ones of the second UWB preamble signals 138_2 in the second sequence Sequence_2. The time differences between different pairs of the adjacent ones of the second UWB preamble signals 138_2 in the second sequence Sequence_2 may vary.

The time of arrival (ToA) of the first UWB preamble signals 138_1 may be unique for the first electronic device 100_1 and may allow for identification of the first electronic device 100_1 by the commodity device 110. Similarly, the ToA of the second UWB preamble signals 138_2 may be unique for the second electronic device 100_2 and may allow for identification of the second electronic device 100_2 by the commodity device 110. For example, the commodity device 110 may use the ToA of the first UWB preamble signals 138_1 to determine the inter-preamble times of the first UWB preamble signals 138_1. The inter-preamble times of the first UWB preamble signals 138_1 may be the idle times between transmissions of adjacent ones of the first UWB preamble signals 138_1 in the first sequence Sequence_1, which may be varied in a systematic manner to create a unique signature for the first electronic device 100_1. The commodity device 110 may also use the ToA of the second UWB preamble signals 138_2 to determine the inter-preamble times of the second UWB preamble signals 138_2. The inter-preamble times of the second UWB preamble signals 138_2 may be the idle times between transmissions of adjacent ones of the second UWB preamble signals 138_2 in the second sequence Sequence_2, which may be varied in a systematic manner to create a unique signature for the second electronic device 100_2.

Some designs may use a payload of a UWB packet (e.g., the payload section of a physical service data unit (PSDU) in a UWB packet) to differentiate between the first and second electronic devices 100_1 and 100_2 such that they can be identified by the commodity device 110. In other words, some designs may use the payload of a UWB packet to differentiate between different UWB transmitters such that they can be identified by a UWB receiver. However, the generation of a complex impulse waveform for the payload of a UWB packet may pose a significant energy burden for the electronic devices 100.

In some embodiments, the first and second electronic devices 100_1 and 100_2 may each employ an energy-efficient coding approach that benefits from preamble-focused energy optimizations. For example, the first and second electronic devices 100_1 and 100_2 may each employ preamble position coding, whereby positions of the first UWB preamble signals 138_1 in the first sequence Sequence_1 and positions of the second UWB preamble signals 138_2 in the second sequence Sequence_2 may be time-varied in a systematic manner to create unique, orthogonal signatures encoded in time-gaps, which may be energy-efficient signatures that help respectively identify the first and second electronic devices 100_1 and 100_2. In this way, the electronic devices 100 can be identified even when a multitude of them access the target UWB channel of a UWB receiver in the commodity device 110 simultaneously.

The preamble position coding operation may allow the electronic devices 100 to leverage their preamble design directly to easily scale and support multiple electronic devices 100, while keeping the design simple, and benefitting from impulse-based energy optimizations. The first UWB preamble signals 138_1 and the second UWB preamble signals 138_2 may thus carry accurate/consistent phase at commercial UWB channels that can be decoded by, for example, a two-antenna UWB receiver included in the commodity device 110 to enable phase difference of arrival (PDoA) based localization. The angle of arrival (AoA) of ones of the first UWB preamble signals 138_1 and ones of the second UWB preamble signals 1382 may be sampled at different spatial points on the commodity device's 110 trajectory to determine the first electronic device's 100_1 location relative to the commodity device 110 and the second electronic device's 100_2 location relative to the commodity device 110.

As discussed above, in some designs, UWB preamble signals may be the same across different UWB transmitters (e.g., different electronic devices 100), and standard UWB packets may carry a variable payload (i.e., PSDU) that follows the preamble and identifies the UWB transmitter. However, in contrast to the UWB preamble signals 138 that each have a fixed sequence of +/−/null UWB impulses (e.g., predefined by the UWB standard based on IEEE 802.15.4) described with reference to FIG. 6, a complicated waveform may need to be generated for sending each symbol within the PSDU. Generation of the complicated waveform may be energy intensive. Thus, in some embodiments, to enable tracking in practical applications, where multiple electronic devices 100 are located in proximity, one of the electronic devices 100 may not only trigger the commodity device 110 to output valid localization data, but may also be identified from other ones of the electronic devices 100, all without incurring the overhead of payload generation (i.e., without sending a UWB signal that includes a PSDU).

Sending the UWB preamble signals 138 alone (i.e., without the payload, PSDU part of the UWB packet) may be sufficient to enable location determination of the electronic devices 100 by the commodity device 110. However, the electronic devices 100 may still need to be distinguished from each other. While electronic devices 100 that are sufficiently far apart from each other may be able to be differentiated based on their varied AoA, this may not always be sufficient for two reasons. First, the commodity device 110 may not be able to distinguish when the electronic devices 100 are close to each other or within the commodity device's 110 AoA detection granularity. Second, the commodity device 110 may still need to know where a specific electronic device 100 is located. To avoid the complex signal characteristics of the PSDU and the associated energy overheads, the electronic devices 100 may communicate their IDs by relying only on the UWB preamble signals 138 (i.e., eliminating PSDU). That is, the UWB preamble signals 138 may be free of a payload, and the electronic devices 100 may be identified by the commodity device 110 via their respective UWB preamble signals 138. In particular, the first electronic device 100_1 may be identified by the commodity device 110 via the first UWB preamble signals 138_1 output in the first sequence Sequence_1, and the second electronic device 100_2 may be identified by the commodity device 110 via the second UWB preamble signals 138_2 output in the second sequence Sequence_2.

The time difference between adjacent ones of the first UWB preamble signals 138_1 in the first sequence Sequence_1 may be used as a primitive for encoding and creating a unique signature/sequence (i.e., ID) for the first electronic device 100_1. For example, the first UWB preamble signals 138_1 may be output in the first sequence Sequence_1 and may be respectively transmitted to the commodity device 110 at times t₁, t₂, t₃ . . . tₖ. The time differences between different pairs of adjacent ones of the first UWB preamble signals 138_1 in the first sequence Sequence_1 may vary. The ToA of the first UWB preamble signals 138_1 may thus allow for identification of the first electronic device 100_1 by the commodity device 110.

The time difference between adjacent ones of the second UWB preamble signals 138_2 in the second sequence Sequence_2 may be used as a primitive for encoding and creating a unique signature/sequence (i.e., ID) for the second electronic device 100_2. For example, the second UWB preamble signals 138_2 may be output in the second sequence Sequence_2 and may be respectively transmitted to the commodity device 110 at times t₁′, t₂′, t₃′ . . . tₖ′. The time differences between different pairs of adjacent ones of the second UWB preamble signals 138_2 in the second sequence Sequence_2 may vary. The ToA of the second UWB preamble signals 1382 may thus allow for identification of the second electronic device 100_2 by the commodity device 110.

The first electronic device 100_1 may be programmed to transmit the first UWB preamble signals 138_1 with varying inter-preamble time differences, based on the first sequence Sequence_1. The second electronic device 100_2 may be programmed to transmit the second UWB preamble signals 138_2 with varying inter-preamble time differences, based on the second sequence Sequence_2. In some embodiments, the logic circuit 118 (see FIG. 2) may time-vary the position of the ones of the first UWB preamble signals 138_1 in the first sequence Sequence_1 and may time-vary the position of the ones of the second UWB preamble signals 138_2 in the second sequence Sequence_2. Each of the first and second electronic devices 100_1 and 100_2 may include the logic circuit 118.

In some embodiments, a set of quasi-orthogonal sequences may be adopted. For example, the first and second sequences Sequence_1 and Sequence_2 may be quasi-orthogonal sequences. These sequences may have good quasi-orthogonality properties even with a short sequence length. This may allow for the electronic devices 100 to be reliably identified and distinguished at the commodity device 110 in moderate channel loads (e.g., at least a few tens of electronic devices 100) in an energy-efficient, real-time manner, even when multiple electronic devices 100 operate simultaneously.

At the UWB receiver side of the commodity device 110, an identification engine may take a two-step approach to increase accuracy. First, it may classify the received UWB preamble signals 138 (e.g., the first UWB preamble signals 138_1 and the second UWB preamble signals 138_2) based on their AoA values. Then, it may separately focus on an AoA cluster of the first UWB preamble signals 138_1 (e.g., Cluster 1) and an AoA cluster of the second UWB preamble signals 138_2 (e.g., Cluster 2) and may further discriminate the respective signatures of the first and second electronic devices 100_1 and 100_2 within each cluster by decoding and separating the interleaved quasi-orthogonal sequences for the first and second sequences Sequence_1 and Sequence_2, respectively. The AoAs of the first and second UWB preamble signals 138_1 and 138_2 may be used by the commodity device 110 to locate the first and second electronic devices 100_1 and 100_2, respectively. The ToAs for the AoA cluster of the first UWB preamble signals 138_1 (e.g., Cluster 1) and the ToAs for the AoA cluster of the second UWB preamble signals 138_2 (e.g., Cluster 2) may be determined by separating the interleaved quasi-orthogonal sequences for the first and second sequences Sequence_1 and Sequence_2, respectively, which may allow the commodity device 110 to determine the respective signatures of the first and second electronic devices 100_1 and 100_2 and enable identification thereof.

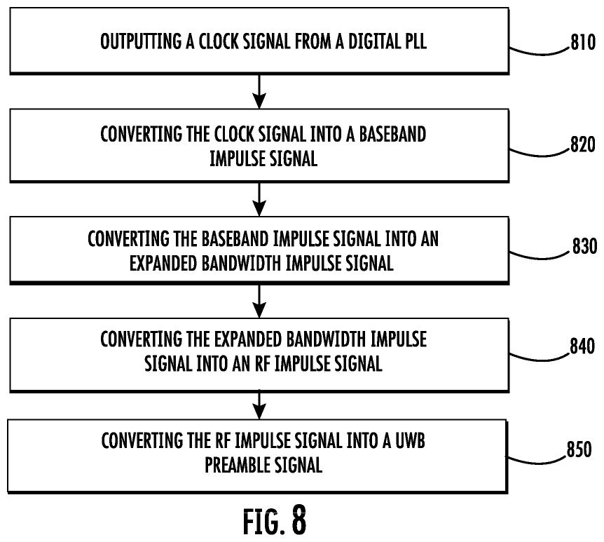

FIG. 8 is a flow chart of methods of generating an ultra-wideband (UWB) signal according to some embodiments.

Referring to FIGS. 2, 3 and 8, the methods may include outputting the clock signal 103 from the digital PLL 112 (BLOCK 810). For example, the clock signal 103 may be a square wave clock signal and may have a frequency of less than 100 MHz. In some embodiments, the clock signal 103 may have a frequency of 31.2 MHz, which may be a PRF of UWB channels.

The methods may further include converting the clock signal 103 into the baseband impulse signal 105 (BLOCK 820). The clock signal 103 may be converted into the baseband impulse signal 105 by passing the clock signal 103 through the high-pass filter 122. The baseband impulse signal 105 may include a plurality of impulses that correspond to rising and falling edges of the clock signal 103, respectively.

The methods may further include converting the baseband impulse signal 105 into the expanded bandwidth impulse signal 107 (BLOCK 830). The baseband impulse signal 105 may be converted into the expanded bandwidth impulse signal 107 by passing the baseband impulse signal 105 through the bandwidth expansion circuit 124. An uppermost frequency of the expanded bandwidth impulse signal 107 may be greater than an uppermost frequency of the baseband impulse signal 105. In some embodiments, the uppermost frequency of the expanded bandwidth impulse signal 107 may be greater than or equal to 3.1 GHz, and the uppermost frequency of the baseband impulse signal 105 may be less than 1 GHz. For example, the uppermost frequency of the expanded bandwidth impulse signal 107 may be greater than or equal to 3.75 GHz. In some embodiments, the uppermost frequency of the expanded bandwidth impulse signal 107 may be greater than 10 GHz, so that it encompasses every UWB channel. For example, the expanded bandwidth impulse signal 107 may be within a portion of a frequency range that spans from 0 Hz to greater than or equal to 10 GHz, and the baseband impulse signal 105 may be within a portion of a frequency range that spans from 0 Hz to less than 1 GHz.

The methods may further include converting the expanded bandwidth impulse signal 107 into the RF impulse signal 109 (BLOCK 840). The expanded bandwidth impulse signal 107 may be converted into the RF impulse signal 109 by passing the expanded bandwidth impulse signal 107 through the band-pass filter 126. The RF impulse signal 109 may have a frequency that corresponds to an operating frequency of a UWB channel. The RF impulse signal 109 may include a sequence of RF impulses with a same phase. The RF impulses may have a frequency that is within a UWB frequency range (e.g., 3.1 to 10.6 GHz). In other words, a frequency of the RF impulse signal 109 may be within a portion of a 3.1-10.6 GHz frequency range. The band-pass filter 126 may have a passband that is within the portion of the 3.1-10.6 GHz frequency range.

Referring to FIGS. 2, 6, and 8, the methods may further include converting the RF impulse signal 109 into the UWB preamble signal 138 (BLOCK 850). A phase modulation operation may be performed on the RF impulse signal 109 to convert the RF impulse signal 109 into the UWB preamble signal 138. For example, the phase modulator 116 may perform phase-shift keying on the RF impulse signal 109 to convert the RF impulse signal 109 into the UWB preamble signal 138. The RF impulse signal 109 may include a plurality of RF impulses, and the UWB preamble signal 138 may include a sequence of the RF impulses that have been modulated (e.g., that have undergone the phase modulation operation). For example, the UWB preamble signal 138 may include a sequence of the RF impulses that have been binary modulated in amplitude and/or phase (i.e., modulated RF impulses), namely a sequence of positive (phase=0°, amplitude=1), negative (phase=180°, amplitude=1), and/or null (amplitude=0) impulses at a fixed rate. The modulated RF impulses included in the UWB preamble signal 138 may also be referred to as UWB impulses.

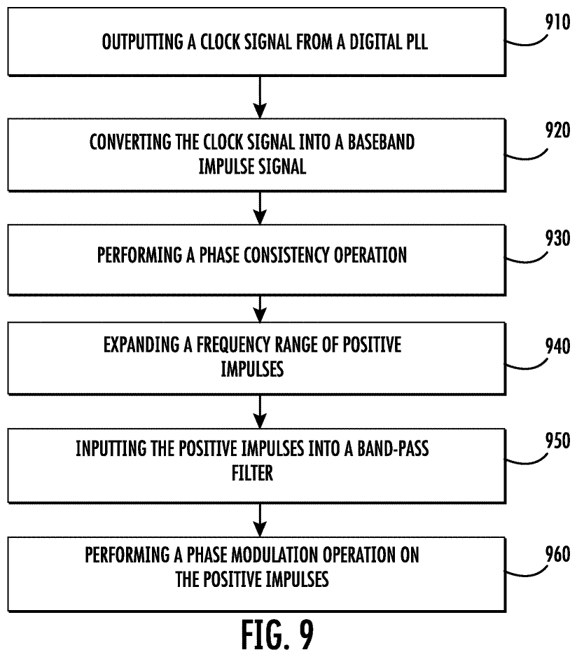

FIG. 9 is a flow chart of methods of split-phase modulation according to some embodiments.

Referring to FIGS. 2, 3 and 9, the methods may include outputting the clock signal 103 from the digital PLL 112 (BLOCK 910). The clock signal 103 may include rising edges and falling edges. In some embodiments, the clock signal 103 may be set to a PRF of a UWB channel (e.g., 31.2 MHz).

The methods may further include converting the clock signal 103 into the baseband impulse signal 105 (BLOCK 920). The clock signal 103 may be converted into the baseband impulse signal 105 by passing the clock signal 103 through the high-pass filter 122. The baseband impulse signal 105 may include a plurality of impulses. The plurality of impulses included in the baseband impulse signal 105 may correspond to the rising and falling edges of the clock signal 103, respectively. For example, the baseband impulse signal 105 may include positive impulses corresponding to the rising edges of the clock signal 103, respectively, and negative impulses corresponding to the falling edges of the clock signal 103, respectively. The positive impulses may have a first phase, and the negative impulses may have a second phase different from the first phase. For example, the positive impulses may have a phase of 0°, and the negative impulses may have a phase of 180°.

The methods may further include performing a phase consistency operation (BLOCK 930). The phase consistency operation may include selecting the positive impulses included in the baseband impulse signal 105 and ignoring the negative impulses included in the baseband impulse signal 105. For example, a split-phase modulation approach may be employed that delivers both low energy consumption and interoperability, whereby only phase consistency is imparted to the baseband impulse signal 105 (i.e., a phase consistency operation), while the modulation itself is imparted later by the phase modulator 116 (i.e., a phase modulation operation). In other words, the electronic device 100 may adopt a split-phase modulation approach that includes the phase consistency operation and the phase modulation operation.

The phase consistency operation may be performed before the phase modulation operation. For example, the phase of the RF impulses included in the RF impulse signal 109 may be consistent (e.g., substantially the same) before they pass through the phase modulator 116 and are converted into the UWB preamble signal 138 (see FIG. 6). This condition may be met by leveraging the fact that the carrier frequency of every target UWB channel may be an integer multiplier of the 31.2 MHz. In some embodiments, the clock signal 103 may have a frequency of 31.2 MHz.

The phase consistency operation may include selecting impulses with the same phase included in the baseband impulse signal 105 that are produced using the clock signal's 103 rising edges (i.e., the positive impulses), while ignoring the negative impulses that are produced using the clock signal's 103 falling edges. For example, the negative impulses may not trigger the bandwidth expansion circuit 124. The expanded bandwidth impulse signal 107 (i.e., an output of the bandwidth expansion circuit 124) may include the positive impulses having an expanded frequency range and may not include the negative impulses. Thus, ignoring the negative impulses may include passing the baseband impulse signal 105 through the bandwidth expansion circuit 124. In other words, the bandwidth expansion circuit 124 may expand a frequency of the positive impulses and may ignore the negative impulses. By splitting the phase modulation process across baseband (phase consistency) and RF (modulation), the electronic device 100 may be able to ensure a low energy footprint.

The methods may further include expanding a frequency range of the positive impulses (BLOCK 940). For example, a frequency range of the positive impulses selected in the phase consistency operation may be expanded by passing the baseband impulse signal 105 through the bandwidth expansion circuit 124. The baseband impulse signal 105 may be converted into the expanded bandwidth impulse signal 107 by passing the baseband impulse signal 105 through the bandwidth expansion circuit 124. The expanded bandwidth impulse signal 107 may include the positive impulses having an expanded frequency range.

In some embodiments, the uppermost frequency of the expanded bandwidth impulse signal 107 may be greater than or equal to 3.1 GHz, and the uppermost frequency of the baseband impulse signal 105 may be less than 1 GHz. For example, the uppermost frequency of the expanded bandwidth impulse signal 107 may be greater than or equal to 3.75 GHz. In some embodiments, the uppermost frequency of the expanded bandwidth impulse signal 107 may be greater than 10 GHz, so that it encompasses every UWB channel. For example, the expanded bandwidth impulse signal 107 may be within a portion of a frequency range that spans from 0 Hz to greater than or equal to 10 GHz, and the baseband impulse signal 105 may be within a portion of a frequency range that spans from 0 Hz to less than 1 GHz.

The methods may further include inputting the positive impulses into the band-pass filter 126 (BLOCK 950). The band-pass filter 126 may isolate the positive impulses included in the expanded bandwidth impulse signal 107 within a target frequency range. The target frequency range may correspond to an operating frequency of a target UWB channel. The expanded bandwidth impulse signal 107 may be converted into the RF impulse signal 109 by passing the expanded bandwidth impulse signal 107 through the band-pass filter 126.

Referring to FIGS. 2, 3, 6, and 9, the methods may further include performing the phase modulation operation on the positive impulses (BLOCK 960). Performing the phase modulation operation on the positive impulses may include phase-shifting at least one of the positive impulses by 180° to generate at least one negative impulse to be included in the UWB preamble signal 138 at super high frequencies (e.g., greater than 3 GHz). In some embodiments, the logic circuit 118 may also block the clock signal 103 at the input of the RF impulse generation circuit 114 (e.g., at the input of the high-pass filter 122) so that no impulse (i.e., a null impulse) may appear at the output of the phase modulator 116. The UWB preamble signal 138 may include a sequence of positive, negative, and/or null UWB impulses.

Performing the phase modulation operation on the positive impulses may include inputting at least one of the positive impulses into the first microstrip line 134 having the first length or the second microstrip line 136 having the second length. The second length may be greater than the first length such that a phase of the at least one of the positive impulses may be shifted by 180° when the at least one of the positive impulses is input into the second microstrip line 136 compared to when the at least one of the positive impulses is input into the first microstrip line 134.

The electronic device 100 may thus perform split-phase modulation. The split-phase modulation may include the phase consistency operation whereby phase consistency is imparted to the baseband impulse signal 105 by selecting positive impulses and ignoring negative impulses included therein. The split-phase modulation may also include the phase modulation operation whereby modulation is imparted to the RF impulse signal 109 by the phase modulator 116 through a passive delay-based (e.g., varied length microstrips) circuit. An industry standards-compliant UWB preamble signal 138 may thus be created at the output of the phase modulator 116 and transmitted to a UWB receiver via the antenna 120.

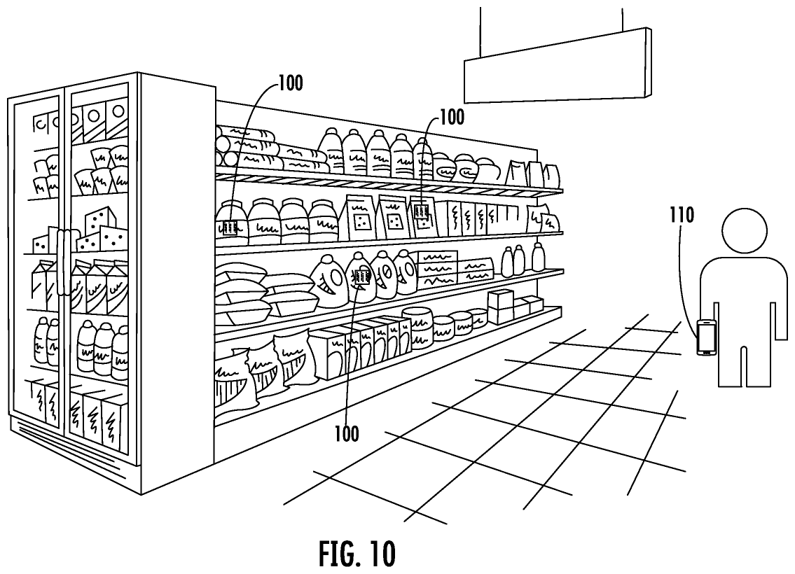

FIG. 10 is a schematic diagram of an example use case for the electronic device 100 according to some embodiments.

Referring to FIG. 10, the electronic devices 100 may be attached to objects (e.g., using an adhesive). The electronic devices 100 may enable tracking of the objects for the commodity device 110 (also referred to as an anchor). The electronic devices 100 may each transmit a UWB signal (e.g., the UWB preamble signal(s) 138 of FIGS. 6 and 7) to the commodity device 110. For example, the commodity device 110 may be a smartphone or other smart device, which serves as a UWB receiver to locate and track the objects. However, the present disclosure is not limited thereto, and the commodity device 110 may be any device capable of receiving a UWB transmission.

The electronic devices 100 may be located by detecting the AoA of the received UWB signals (e.g., the received UWB preamble signal(s) 138 of FIGS. 6 and 7). Further, the ToA of the received UWB signals may allow identification of the electronic devices 100 by the commodity device 110 based on the preamble position coding operation described with reference to FIG. 7.

For example, the electronic devices 100 may have various applications such as object-tracking applications for consumers that range from locating misplaced household objects (e.g., keys, wallets, passports, etc.) to inventory tracking (e.g., tracking household food/cleaning supplies). The electronic devices 100 may be deployed in large enterprise environments, where the commodity device 110 is able to localize multiple electronic devices 100 that are in its vicinity as it moves around the environment. The electronic devices 100 may be used for a quick inventory in supply chains as the commodity device 110 moves around. While FIG. 10 illustrates that the electronic devices 100 are employed for an object-tracking application (e.g., in a grocery store setting), this is merely an example, and the present disclosure is not limited thereto. The electronic devices 100 may have various other applications beyond object-tracking applications.

The electronic devices 100 (and object(s) which they are attached to) may also be integrated, for example, into immersive applications (e.g., augmented reality (AR) and/or virtual reality (VR)) on the commodity device 110. As the commodity device 110 moves in the environment, its own relative motion may be tracked through a combination of one or more of its RF, inertial and/or visual sensors (e.g., through odometry and/or sensor fusion). By reading UWB signals transmitted from the electronic devices 100 at various locations, coupled with its own relative motion trajectory, the commodity device 110 may be able to accurately locate the electronic devices 100. The electronic device 100 is not limited to the use cases and applications set forth herein. Those skilled in the art will appreciate that there are many applications for the electronic device 100.

According to some embodiments, the electronic device 100 may be an ultra-low power, long-lasting wireless tag device that may be capable of generating high-bandwidth UWB signals that may be decoded and used for accurate tracking by the commodity device 110.

The foregoing is illustrative of the present disclosure and is not to be construed as limiting thereof. Although a few example embodiments have been described, those skilled in the art will readily appreciate that many modifications are possible in the example embodiments without materially departing from the teachings of the present disclosure. Accordingly, all such modifications are intended to be included within the scope of this present disclosure as defined in the claims. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims.

1. An electronic device comprising:
a digital phase-locked loop (PLL) configured to output a clock signal;
a high-pass filter configured to receive the clock signal and convert the clock signal into a baseband impulse signal; and
a bandwidth expansion circuit configured to receive the baseband impulse signal and convert the baseband impulse signal into an expanded bandwidth impulse signal, wherein an uppermost frequency of the expanded bandwidth impulse signal is greater than an uppermost frequency of the baseband impulse signal.

2. The electronic device of claim 1, wherein the uppermost frequency of the baseband impulse signal is less than 1 GHz.

3. (canceled)

4. The electronic device of claim 1, wherein the uppermost frequency of the expanded bandwidth impulse signal is greater than or equal to 3.75 GHz.

5. (canceled)

6. The electronic device of claim 1, wherein a frequency of the clock signal is less than 100 MHz.

7. The electronic device of claim 1, wherein the bandwidth expansion circuit comprises a radio frequency (RF) matching circuit, and
wherein the electronic device further comprises a band-pass filter configured to receive the expanded bandwidth impulse signal from the RF matching circuit and convert the expanded bandwidth impulse signal into an RF impulse signal.

8. The electronic device of claim 7, wherein the RF impulse signal has a frequency that corresponds to an operating frequency of an ultra-wideband (UWB) channel.

9. The electronic device of claim 7, wherein the band-pass filter is configured to have a passband that is within a portion of a 3.1-10.6 GHz frequency range.

10. (canceled)

11. The electronic device of claim 7, further comprising a phase modulator configured to receive the RF impulse signal and convert the RF impulse signal into an ultra-wideband (UWB) preamble signal.

12. The electronic device of claim 11, wherein the phase modulator is configured to perform phase-shift keying on the RF impulse signal.

13. The electronic device of claim 11, wherein the RF impulse signal comprises a plurality of RF impulses, and
wherein the phase modulator is configured to shift a phase of at least one of the RF impulses by 180°.

14-19. (canceled)

20. The electronic device of claim 1, wherein the baseband impulse signal comprises an impulse that has a pulse width of less than one nanosecond.

21-28. (canceled)

29. A wireless tag device comprising:
a phase modulator configured to receive radio frequency (RF) impulse signals and convert the RF impulse signals into ultra-wideband (UWB) preamble signals,
wherein the wireless tag device is configured to output the UWB preamble signals in a sequence and time-vary a position of ones of the UWB preamble signals in the sequence, thereby creating a signature for the UWB preamble signals that corresponds to the wireless tag device.

30. The wireless tag device of claim 29, wherein the signature for the UWB preamble signals is encoded based on time differences between adjacent ones of the UWB preamble signals in the sequence.

31. The wireless tag device of claim 30, wherein the time differences between different pairs of the adjacent ones of the UWB preamble signals in the sequence varies.

32. The wireless tag device of claim 29, wherein the sequence is a quasi-orthogonal sequence.

33-37. (canceled)

38. The wireless tag device of claim 29, wherein the phase modulator comprises a first microstrip line having a first length and a second microstrip line having a second length greater than the first length,
wherein each of the RF impulse signals comprises a plurality of RF impulses, and
wherein the second microstrip line is configured to shift a phase of at least one of the RF impulses by 180°.

39-41. (canceled)

42. An electronic device comprising:
a digital phase-locked loop (PLL) configured to output a clock signal having a frequency of 31.2 MHz; and
a radio frequency (RF) impulse generation circuit configured to up-convert the frequency of the clock signal and generate an RF impulse signal.

43. The electronic device of claim 42, wherein a frequency of the RF impulse signal is within a portion of a 3.1-10.6 GHz frequency range.

44. The electronic device of claim 42, wherein a frequency of the RF impulse signal corresponds to an operating frequency of an ultra-wideband (UWB) channel.

45. The electronic device of claim 42, wherein the RF impulse generation circuit is free of an RF oscillator and an RF PLL.

46. The electronic device of claim 42, wherein the RF impulse generation circuit comprises a high-pass filter configured to receive the clock signal and convert the clock signal into a baseband impulse signal.

47. The electronic device of claim 46, wherein the RF impulse generation circuit further comprises a bandwidth expansion circuit configured to receive the baseband impulse signal and convert the baseband impulse signal into an expanded bandwidth impulse signal, and
wherein an uppermost frequency of the expanded bandwidth impulse signal is greater than an uppermost frequency of the baseband impulse signal.

48-60. (canceled)
